(19) United States
(12) Patent Application Publication
(10) Pub. No.: US 2026/0371333 A1
(43) Pub. Date: Nov. 19, 2026

(54) TERMINAL, BASE STATION, RADIO COMMUNICATION SYSTEM, AND RADIO COMMUNICATION METHOD

(71) Applicant: NTT DOCOMO, INC., Tokyo (JP)

(72) Inventors: Mayuko OKANO, Tokyo (JP); Hiroki HARADA, Tokyo (JP); Masaya OKAMURA, Tokyo (JP)

(73) Assignee: NTT DOCOMO, INC., Tokyo (JP)

(21) Appl. No.: 19/126,323

(22) PCT Filed: Nov. 7, 2022
(86) PCT No.: PCT/JP2022/041439

§ 371 Date: May 1, 2025

(51) Int. Cl. H04W 72/0457; H04W 72/232

(52) U.S. Cl. CPC H04W 72/0457; H04W 72/232

(57) ABSTRACT

A terminal includes a receiving unit that receives single specific downlink control information for scheduling channels to be transmitted on two or more carriers; and a control unit that assumes, using a specification method, a sub-group to be applied to a specific type which a field included in the specific downlink information has. The specific type is a type that has one field which specifies information common to one or more carriers included in the sub-group.

### TECHNICAL FIELD

The present disclosure relates to a terminal, a base station, a radio communication system, and a radio communication method that support a mechanism of scheduling PDSCHs or PUSCHs to be transmitted on two or more CCs, using a single DCI to be transmitted on a CC.

### BACKGROUND ART

The 3rd Generation Partnership Project (3GPP) has prepared a specification for the 5th generation mobile communication system (also called 5G, New Radio (NR), or Next Generation (NG) ) and is also preparing next generation specifications called Beyond 5G, 5G Evolution, or 6G.

In addition, in 3GPP Release 18, CA (Carrier Aggregation) for both intra-band and inter-band is considered. Specifically, introduction of a mechanism of scheduling PDSCHs (Physical Downlink Shared Channels) or PUSCHS (Physical Uplink Shared Channels) to be transmitted. two or more CCs, using a single DCI (Downlink Control Information) to be transmitted on a CC (Component Carrier) is considered. Such a mechanism may be called Single DCI Multi-carrier PDSCH/PUSCH scheduling or Single DCI Multi-Cell PDSCH/PUSCH scheduling (Non-Patent Literature 1).

### CITATION LIST

### Non-Patent Literature

### Non Patent Literature 1

“New WID on Multi-carrier enhancements”, RP-213577, 3GPP TSG RAN Meeting #94e, 3GPP, December 2021

### SUMMARY OF INVENTION

Incidentally, there are considered introduction of a new DCI as a DCI to be used in Single DCI Multi-carrier PDSCH/PUSCH scheduling, and introduction of the following three types as field types included in the new DCI: a type (Type 1A to Type 1C) which has a single field for reporting information common to two or more cells (Co-scheduled cells); a type (Type 2) which has a separate field for each of two or more cells (Co-scheduled cells); and a type (Type 3) which separately uses, depending on an explicit configuration, either: a common field or a separate field for each of two or more cells (Co-scheduled cells); or a separate field for each sub-group including one or more cells included in the two or more cells.

Under such a background, the inventors find, after diligent study, the necessity of clarifying how to define a sub-group to be applied to Type 3.

Accordingly, the present disclosure has been made to solve the above issue, and an object thereof is to provide a terminal, a base station, a radio communication system, and a radio communication method that enable to appropriately assume a sub-group in a DCI including a Type 3 field.

An aspect of the disclosure is a terminal including: a receiving unit that receives single specific downlink control information for scheduling channels to be transmitted on two or more carriers; and a control unit that assumes, using a specification method, a sub-group to be applied to a specific type which a field included in the specific downlink information has, wherein the specific type is a type that has one field which specifies information common to one or more carriers included in the sub-group.

Another aspect of the disclosure is a base station including: a transmitting unit that transmits single specific downlink control information for scheduling channels to be transmitted on two or more carriers; and a control unit that assumes, using a specification method, a sub-group to be used in a specific type which a specific field included in the specific downlink information has, wherein the specific type is a type that has one field which specifies information common to one or more carriers included in the sub-group.

Another aspect of the disclosure is a radio communication system including: a terminal; and a base station, wherein the terminal includes: a receiving unit that receives single specific downlink control information for scheduling channels to be transmitted on two or more carriers; and a control unit that assumes, using a specification method, a sub-group to be applied to a specific type which a field included in the specific downlink information has, wherein the specific type is a type that has one field which specifies information common to one or more carriers included in the sub-group.

Another aspect of the disclosure is a radio communication method including: a step A of receiving single specific downlink control information for scheduling channels to be transmitted on two or more carriers; and a step B of assuming, using a specification method, a sub-group to be applied to a specific type which a field included in the specific downlink information has, wherein the specific type is a type that has one field which specifies information common to one or more carriers included in the sub-group.

### BRIEF DESCRIPTION OF DRAWINGS

FIG. 1 is an overall schematic configuration diagram of a radio communication system 10.

FIG. 2 is a diagram illustrating frequency ranges used in the radio communication system 10.

FIG. 3 is a diagram illustrating a configuration example of a radio frame, a subframe, and a slot used in the radio communication system 10.

FIG. 4 is a functional block configuration diagram of a UE 200.

FIG. 5 is a functional block configuration diagram of a gNB 100.

FIG. 6 is a diagram for explaining Self carrier scheduling.

FIG. 7 is a diagram for explaining Cross carrier scheduling.

FIG. 8 is a diagram for explaining Multi carrier scheduling.

FIG. 9 is a diagram for explaining an operation example.

FIG. 10 is a diagram for explaining an operation example.

FIG. 11 is a diagram illustrating a hardware configuration example of the gNB 100 and the UE 200.

FIG. 12 is a diagram illustrating a configuration example of a vehicle 2001.

### MODES FOR CARRYING OUT THE INVENTION

Hereinafter, an embodiment will be described based on the drawings. Note that, the same functions and configurations are denoted by the same or similar reference signs, and their description will be omitted as appropriate.

### Embodiment

(1) Overall Schematic Configuration of Radio Communication System

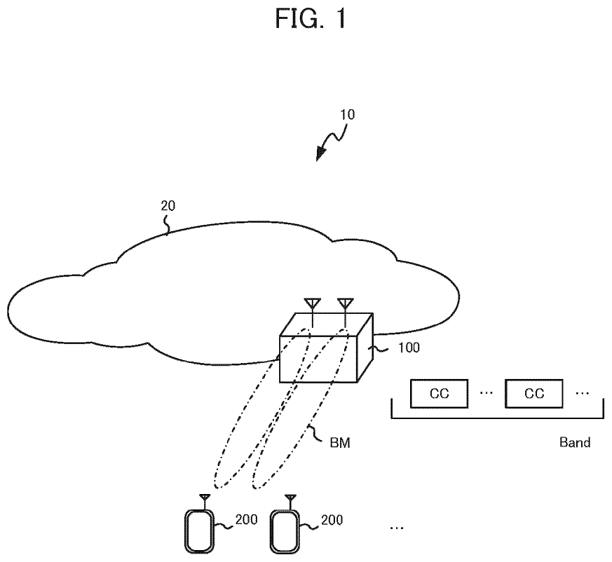

FIG. 1 is an overall schematic configuration diagram of a radio communication system 10 according to the embodiment. The radio communication system 10 is a radio communication system according to 5G New Radio (NR), and includes a Next Generation-Radio Access Network 20 (hereinafter, NG-RAN 20) and a terminal 200 (hereinafter, User Equipment (UE) 200).

Note that, the radio communication system 10 may be a radio communication system according to a scheme called Beyond 5G, 5G Evolution, or 6G.

The NG-RAN 20 includes a base station 100 (hereinafter, gNB 100). Note that, the specific configuration of the radio communication system 10 including the number of gNBs 100 and UEs 200 is not limited to that of the example illustrated in FIG. 1.

The NG-RAN 20 actually includes multiple NG-RAN Nodes, specifically, gNBs (or ng-eNBs), and is connected to a core network (5GC, not illustrated) according to 5G. Note that, the NG-RAN 20 and 5GC may be simply expressed as a “network”.

The gNB 100 is a radio base station according to 5G, and performs radio communication with the UE 200 according to 5G. The gNB 100 and the UE 200 can be compatible with Massive MIMO (Multiple-Input Multiple-Output) that generates a beam BM with higher directivity by controlling radio signals transmitted from multiple antenna elements, carrier aggregation (CA) that uses multiple component carriers (CCs) in a bundle, dual connectivity (DC) that communicates with two or more transport blocks at the same time between the UE and each of two NG-RAN Nodes, and the like.

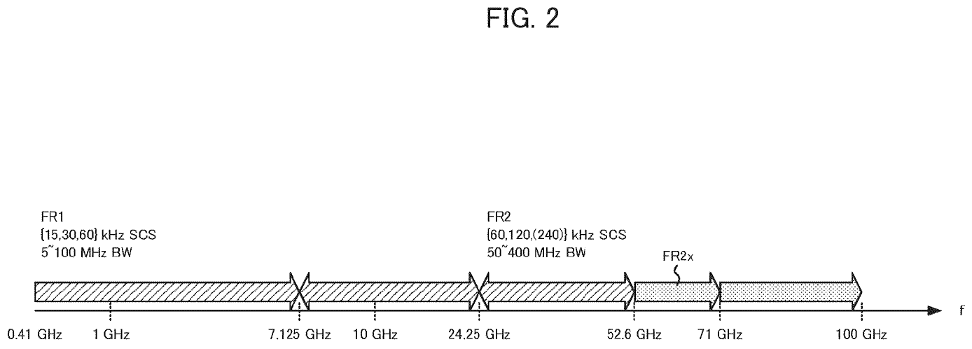

In addition, the radio communication system 10 is compatible with multiple frequency ranges (FRs). FIG. 2 is a diagram illustrating frequency ranges used in the radio communication system 10.

As illustrated in FIG. 2, the radio communication system 10 is compatible with an FR1, an FR2-1, and an FR2-2. Frequency bands of the respective FRs are as follows.
FR1: 410 MHz to 7.125 GHZ
FR2-1: 24.25 GHz to 52.6 GHZ
FR2-2: 52.6 GHz to 71 GHZ

In the FR1, a Sub-Carrier Spacing (SCS) of 15, 30, or 60 kHz may be used, and a bandwidth (BW) of 5 to 100 MHz may be used. The FR2-1 has a higher frequency than the FR1, the SCS of 60 or 120 kHz (240 kHz may be included) may be used, and the bandwidth (BW) of 50 to 400 MHZ may be used. FR2-2 has a higher frequency than FR2-1, the SCS of 120, 480 kHz, or 960 kHz may be used, and the bandwidth (BW) of 400 to 2000 MHz may be used.

Note that, the SCS may be interpreted as numerology. The numerology is defined in 3GPP TS 38.300 and corresponds to one sub-carrier spacing in a frequency domain.

Further, the radio communication system 10 is also compatible with a higher frequency band than the FR2-2 frequency band. Specifically, the radio communication system 10 is compatible with a frequency band greater than 52.6 GHZ and up to 71 GHz or 114.25 GHZ. Such a high frequency band may be called “FR2x” for convenience.

In order to solve the problem that the influence of phase noise becomes larger in the high frequency band, when using a band exceeding 52.6 GHZ, Cyclic Prefix-Orthogonal Frequency Division Multiplexing (CP-OFDM)/Discrete Fourier Transform-Spread (DFT-S-OFDM) having larger Sub-Carrier Spacing (SCS) may be applied.

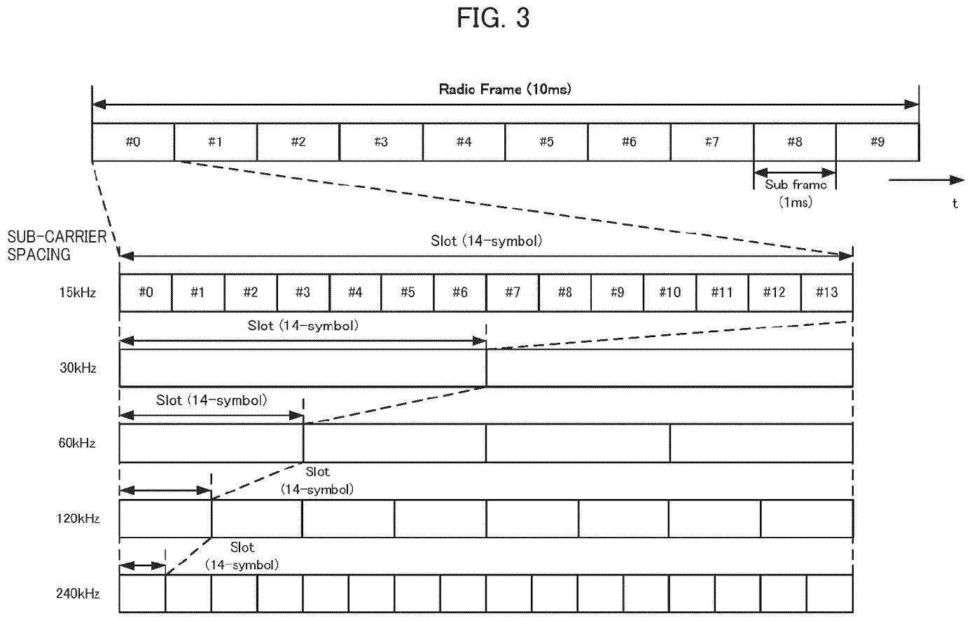

FIG. 3 is a diagram illustrating a configuration example of a radio frame, a subframe, and a slot used in the radio communication system 10.

As illustrated in FIG. 3, one slot includes 14 symbols, and a symbol period (and a slot period) becomes shorter as the SCS becomes larger (wider). The SCS is not limited to the interval (frequency) illustrated in FIG. 3. For example, 480 KHz, 960 KHz, or the like may be used.

In addition, the number of symbols constituting one slot is not necessarily 14 symbols (for example, 28 symbols or 56 symbols). Further, the number of slots per subframe may be different depending on the SCS.

Note that, a time direction (t) illustrated in FIG. 3 may be called a time domain, a symbol period, a symbol time, or the like. In addition, a frequency direction may be called a frequency domain, a resource block, a subcarrier, a Bandwidth Part (BWP), or the like.

A DMRS is a kind of reference signal, and is prepared for various channels. Here, unless otherwise specified, it may mean a downlink data channel, specifically, a DMRS for PDSCH (Physical Downlink Shared Channel). However, an uplink data channel, specifically, a DMRS for PUSCH (Physical Uplink Shared Channel) may be construed as being similar to a DMRS for PDSCH.

The DMRS may be used for channel estimation at the UE 200 as part of a device, e. g., coherent demodulation. The DMRS may exist only in resource blocks (RBs) used for PDSCH transmission.

The DMRS may have multiple mapping types. Specifically, the DMRS has a mapping type A and a mapping type B. In the mapping type A, the first DMRS is allocated in the second or third symbol of a slot. In the mapping type A, the DMRS may be mapped based on a boundary between slots regardless of where in a slot actual data transmission starts. The reason why the first DMRS is allocated in the second or third symbol of a slot may be construed as for the purpose of allocating the first DMRS after control resource sets (CORESET).

In the mapping type B, the first DMRS may be allocated in the first symbol of data assignment. In other words, the DMRS may be given relatively to a location where data is allocated, not to the boundary between slots.

Further, the DMRS may have multiple types (Types). Specifically, the DMRS has a Type 1 and a Type 2. The Type 1 and Type 2 are different in mapping and the maximum number of orthogonal reference signals in a frequency domain. The Type 1 can output up to four orthogonal signals in a single-symbol DMRS, and the Type 2 can output up to eight orthogonal signals in a double-symbol DMRS.

### (2) Functional Block Configuration of Radio Communication System

Next, a functional block configuration of the radio communication system 10 will be described.

First, a functional block configuration of the UE 200 will be described.

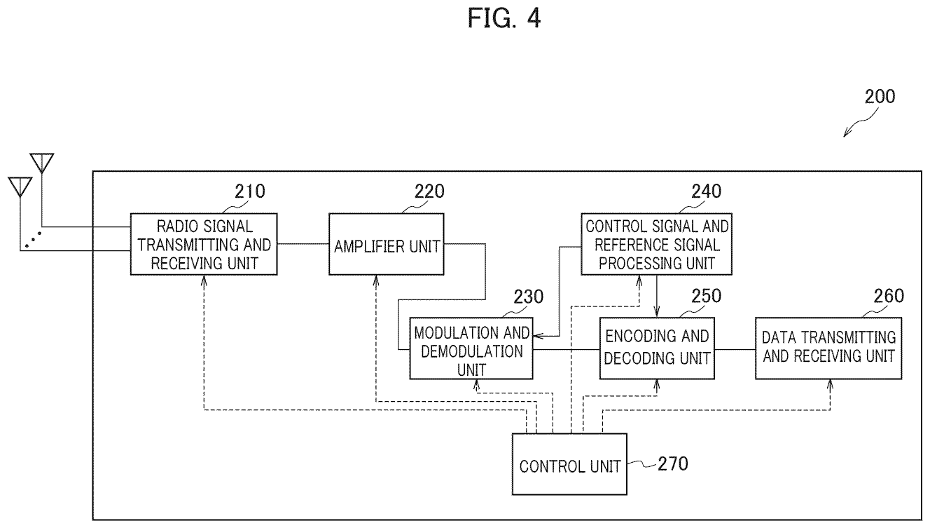

FIG. 4 is a functional block configuration diagram of the UE 200. As illustrated in FIG. 4, the UE 200 includes a radio signal transmitting and receiving unit 210, an amplifier unit 220, a modulation and demodulation unit 230, a control signal and reference signal processing unit 240, an encoding and decoding unit 250, a data transmitting and receiving unit 260, and a control unit 270.

The radio Signal Transmitting and Receiving Unit 210 transmits and receives a radio signal according to NR. The radio signal transmitting and receiving unit 210 deals with Massive MIMO, CA in which multiple CCs are bundled and used, DC in which communication is simultaneously performed between the UE and each of two NG-RAN Nodes, and the like.

The amplifier unit 220 includes a PA (Power Amplifier)/LNA (Low Noise Amplifier) and the like. The amplifier unit 220 amplifies a signal output from the modulation and demodulation unit 230 to a predefined power level. In addition, the amplifier unit 220 amplifies an RF signal output from the radio signal transmitting and receiving unit 210.

The modulation and demodulation unit 230 executes data modulation and demodulation, transmission power setting, resource block assignment, and the like for each predefined communication destination (gNB 100 or another gNB). In the modulation and demodulation unit 230, Cyclic Prefix-Orthogonal Frequency Division Multiplexing (CP-OFDM)/Discrete Fourier Transform-Spread (DFT-S-OFDM) may be applied. Further, DFT-S-OFDM may be used not only for uplink (UL) but also for downlink (DL).

The control signal and reference signal processing unit 240 executes processing related to various control signals transmitted and received by the UE 200, and processing related to various reference signals transmitted and received by the UE 200.

Specifically, the control signal and reference signal processing unit 240 receives various control signals transmitted from the gNB 100 via a predefined control channel, for example, a control signal of a radio resource control layer (RRC). Further, the control signal and reference signal processing unit 240 transmits various control signals to the gNB 100 via a predefined control channel.

The control signal and reference signal processing unit 240 executes processing using a reference signal (RS) such as a Demodulation Reference Signal (DMRS) and a Phase Tracking Reference Signal (PTRS).

The DMRS is a known terminal-specific reference signal (pilot signal) between the base station and the terminal for estimating a phasing channel used for data demodulation. The PTRS is a terminal-specific reference signal designed for the purpose of estimating phase noise that is a problem in a high frequency band.

Note that, the reference signal may include a Channel State Information-Reference Signal (CSI-RS), a Sounding Reference Signal (SRS), and a Positioning Reference Signal (PRS) for position information, in addition to the DMRS and the PTRS.

In addition, the channel includes a control channel and a data channel. The control channel includes a PDCCH (Physical Downlink Control Channel), a PUCCH (Physical Uplink Control Channel), a RACH (Random Access Channel), Downlink Control Information (DCI) including a Random Access Radio Network Temporary Identifier (RA-RNTI), a Physical Broadcast Channel (PBCH), and the like.

In addition, the data channel includes a PDSCH (Physical Downlink Shared Channel), a PUSCH (Physical Uplink Shared Channel), and the like. Data means data transmitted via the data channel. The data channel may be interchanged with a shared channel.

Here, the control signal and reference signal processing unit 240 may receive downlink control information (DCI). The DCI includes, as existing fields, fields for storing DCI Formats, Carrier indicator (CI), BWP indicator, FDRA (Frequency Domain Resource Assignment), TDRA (Time Domain Resource Assignment), MCS (Modulation and Coding Scheme), HPN (HARQ Process Number), NDI (New Data Indicator), RV (Redundancy Version), and the like.

A value stored in the DCI Format field is an information element specifying the format of the DCI. A value stored in the CI field is an information element specifying a CC for which the DCI is applied. A value stored in the BWP indicator field is an information element specifying a BWP for which the DCI is applied. The BWP that can be specified by the BWP indicator is configured by an information element (BandwidthPart-Config) included in an RRC message. A value stored in the FDRA field is an information element specifying a frequency domain resource for which the DCI is applied. The frequency domain resource is identified by a value stored in the FDRA field and an information element (RA Type) included in the RRC message. A value stored in the TDRA field is an information element specifying a time domain resource for which the DCI is applied. The time domain resource is identified by a value stored in the TDRA field and an information element (pdsch-TimeDomainAllocationList, pusch-TimeDomainAllocationList) included in the RRC message. The time domain resource may be identified by a value stored in the TDRA field and a default table. A value stored in the MCS field is an information element specifying an MCS for which the DCI is applied. The MCS is identified by a value stored in the MCS and an MCS table. The MCS table may be specified by the RRC message, or may be identified by RNTI scrambling. A value stored in the HPN field is an information element specifying a HARQ Process for which the DCI is applied. A value stored in the NDI is an information element for identifying whether data for which the DCI is applied is first transmission data. A value stored in the RV field is an information element specifying redundancy of data for which the DCI is applied.

In the embodiment, the control signal and reference signal processing unit 240 receives downlink control information (hereinafter, DCI).

The DCI may include a DCI that has been used prior to Release 17 (hereinafter, existing DCI). The existing DCI may be called a first DCI. A format of the existing DCI may include one or more selected from DCI formats 0_0/ 0_1/ 0_2/ 1_0/ 1_1/ 1_2/ 2_0/ 2_1/ 2_2/ 2_3/ 2_4/ 2_5/ 2_4/ 2_5/ 2_6/ 2_7/ 3_0/ 3_1/ 4_0/ 4_1/ 4_2. These DCI formats may be specified in TS38.212 V17.2.0 $7.3 “Downlink control information”. The DCI having DCI format 0_0/ 1_0 may be called a fallback DCI. The DCI having DCI format 0_2/ 1_2 may be called a compact DCI. The DCI having DCI format 0_1/ 1_1 may be called a non-fallback DCI.

In addition, the DCI may include single specific downlink control information (hereinafter, specific DCI) for scheduling channels to be transmitted on two or more carriers. The specific DCI may be called a second DCI in contrast to the existing DCI. The channels scheduled using the single specific DCI may be PDSCHs or PUSCHS.

Here, the mechanism of scheduling PDSCHs or PUSCHs to be transmitted on two or more CCs, using the single specific DCI to be transmitted on a CC, is a newly introduced mechanism. Such a mechanism may be called Single DCI Multi-carrier PDSCH/PUSCH scheduling, Single DCI Multi-Cell PDSCH/PUSCH scheduling, or the like. The format of the specific DCI may be called DCI formats 0_X, 1_X, or DCI formats 0_3, 1_3.

As described above, in the embodiment, the control signal and reference signal processing unit 240 includes a receiving unit that receives single specific downlink control information (specific DCI) for scheduling channels to be transmitted on two or more carriers. Here, a carrier may be read as a CC or a cell.

The encoding and decoding unit 250 performs data division and coupling, channel coding and decoding, and the like for each predefined communication destination (gNB 100 or another gNB).

Specifically, the encoding and decoding unit 250 divides data output from the data transmitting and receiving unit 260 into predefined sizes, and performs channel coding on the divided data. Further, the encoding and decoding unit 250 decodes data output from the modulation and demodulation unit 230 and couples the decoded data.

The data transmitting and receiving unit 260 transmits and receives a Protocol Data Unit (PDU) and a Service Data Unit (SDU). Specifically, the data transmitting and receiving unit 260 performs assembly and disassembly of the PDU and SDU in multiple layers (a media access control layer (MAC), a radio link control layer (RLC), a packet data convergence protocol layer (PDCP), and the like). In addition, the data transmitting and receiving unit 260 executes error correction and retransmission control of data on the basis of HARQ (Hybrid Automatic Repeat Request).

The control unit 270 controls each of functional blocks configuring the UE 200. In the embodiment, the control unit 270 includes a control unit that assumes, using a specification method, a sub-group to be applied to a specific type which a field included in specific downlink information (specific DCI) has. The specific type is a type having one field for specifying information common to one or more carriers included in the sub-group. Details of the specification method and the specific type will be described below.

Second, a functional block configuration of the gNB 100 will be described.

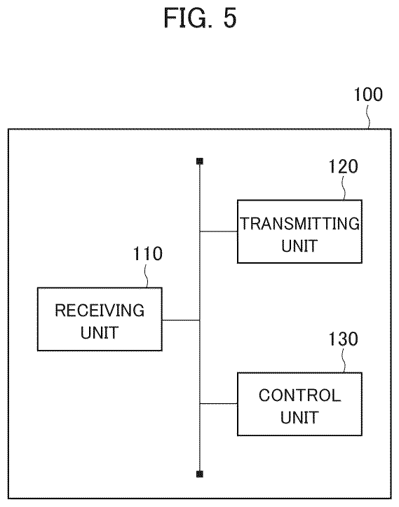

FIG. 5 is a functional block configuration diagram of the gNB 100. As illustrated in FIG. 5, the gNB 100 has a receiving unit 110, a transmitting unit 120, and a control unit 130.

The receiving unit 110 receives various signals from the UE 200. The receiving unit 110 may receive a UL signal via a PUCCH or a PUSCH.

The transmitting unit 120 transmits various signals to the UE 200. The transmitting unit 120 may transmit a DL signal via a PDCCH or a PDSCH. In the embodiment, the transmitting unit 120 includes a transmitting unit that transmits single specific downlink control information (specific DCI) for scheduling channels to be transmitted on two or more carriers.

The control unit 130 controls the gNB 100. In the embodiment, the control unit 130 includes a control unit that assumes, using a specification method, a sub-group to be applied to a specific type which a field included in specific downlink information (specific DCI) has.

### (3) Issue

First, the types of scheduling will be described.

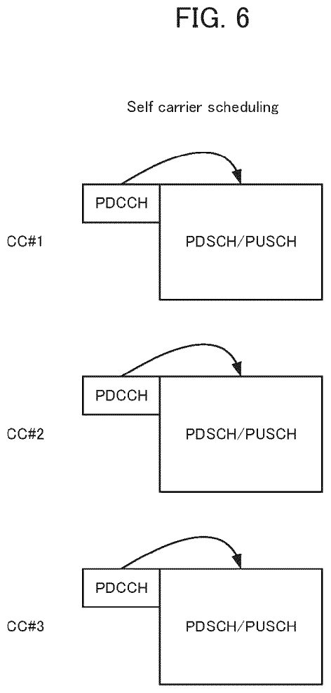

As illustrated in FIG. 6, a method of scheduling a PDSCH/PUSCH of a CC using a PDCCH (DCI) of the CC (hereinafter, Self carrier scheduling) is assumed. For example, a PDSCH/PUSCH of CC #1 is scheduled using DCI of CC #1, a PDSCH/PUSCH of CC #2 is scheduled using a DCI of CC #2, and a PDSCH/PUSCH of CC #3 is scheduled using a DCI of CC #3.

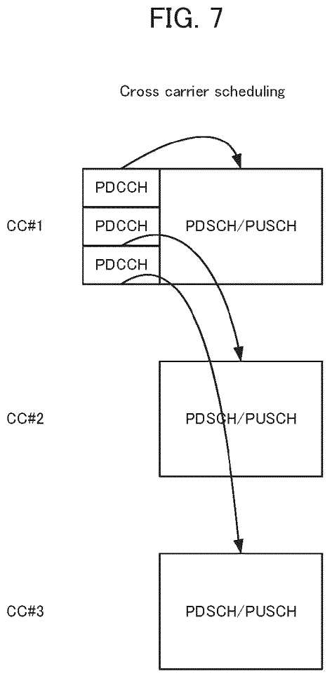

As illustrated in FIG. 7, a method of scheduling PDSCHs/PUSCHs of different CCs using a PDCCH (DCI) of a CC (hereinafter, Cross carrier scheduling) is assumed. For example, a PDSCH/PUSCH of CC #1 is scheduled using a DCI of CC #1, a PDSCH/PUSCH of CC #2 is scheduled using another DCI of CC #1, and a PDSCH/PUSCH of CC #3 is scheduled using another DCI of CC #1. In Cross carrier scheduling, a DCI scheduling the PDSCH/PUSCH of each CC is transmitted separately.

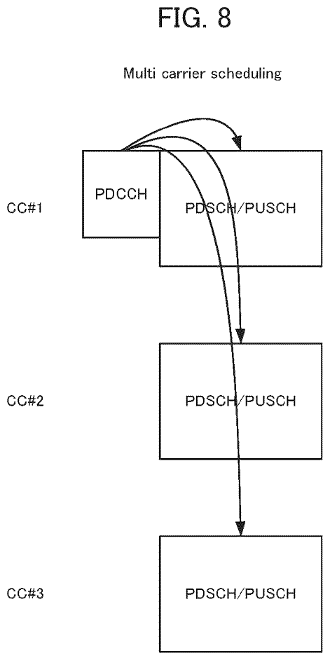

As illustrated in FIG. 8, a method of scheduling PDSCHs/PUSCHs of two or more CCs using a single PDCCH (DCI) of a CC (hereinafter, Multi carrier scheduling) is assumed. For example, a single DCI of CC #1 is used to schedule PDSCHs/PUSCHS of CC #1, CC #2, and CC #3. Multi carrier scheduling is synonymous with Single DCI Multi-carrier PDSCH/PUSCH scheduling. As described above, Multi carrier scheduling is a mechanism that is newly introduced.

Here, the DCIs used in self carrier scheduling and cross carrier scheduling are the existing DCI (for example, DCI formats 0_0/ 0_1/ 0_2/ 1_0/ 1_1/ 1_2, etc). In contrast, the DCI used in Multi carrier scheduling is a specific DCI (for example, DCI formats 0_X/1_X).

Second, types of a field included in the specific DCI used in Multi carrier scheduling will be described. As the types of the field, the following types are considered.

Type 1A to Type 1C are types having a single field for reporting information common to two or more cells (Co-scheduled cells). Specifically, Type 1A is a type having a single field for specifying common information for all cells (Co-scheduled cells). Type 1B is a type having a single field for specifying separate information for each of the cells (Co-scheduled cells) in a joined manner (joint indication). Type 1C is a type having a single field for specifying information for one cell (Co-scheduled cell). Although there are no particular limitations, the type of DCI Format Indicator may be Type 1A.

Type 2 is a type having a separate field for each of two or more cells (Co-scheduled cells). Although there are no particular limitations, the type of RV and NDI may be Type 2.

Type 3 is a type separately using, depending on an explicit configuration, either: a common filed or a separate field for each of two or more cells (Co-scheduled cells); or a separate field for each sub-group including one or more cells included in the two or more cells. In the embodiment, Type 3 is an example of a specific type having one field specifying information common to one or more carriers included in the sub-group.

Under such a background, the inventors note, after diligent study, that details of sub-groups applied to Type 3 are not studied, and find the necessity of clarifying how to define the sub-groups. In addition, the inventors also find, after diligent study, the necessity of clarifying constraints on a set of cells that can be scheduled using the specific DCI.

### (4) Operation Examples

In order to solve the above issue, the following operation examples may be specified. In the operation examples, the following assumptions are made.

First, when a function of executing PUSCH/PDSCH scheduling for two or more cells using a single specific DCI (Multi carrier scheduling) is configured, a set of cells that can be scheduled using the specific DCI is configured. The set of cells may be configured in a table format. The set of cells may be configured using RRC signaling.

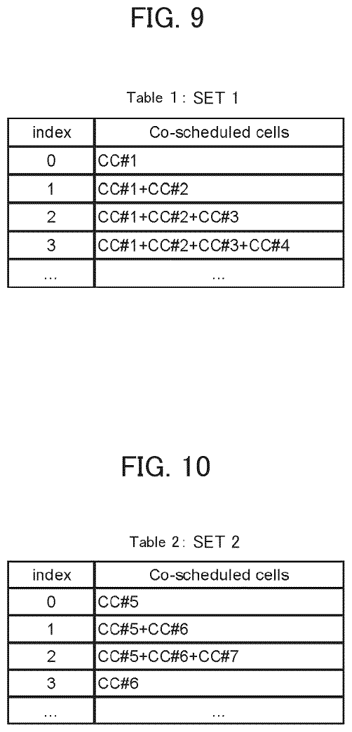

For example, the number of tables each defining the set of cells may be one, or two or more. The table may associate indexes with Co-scheduled cells, as illustrated in FIGS. 9 and 10.

As illustrated in FIG. 9, in Table 1, the set of cells may be a set of any of CC #1 to CC #4. In such a case, index 0 may be associated with CC #1, index 1 may be associated with CC #1 and CC #2, index 2 may be associated with CC #1, CC #2, and CC #3, and index 3 may be associated with CC #1, CC #2, CC #3, and CC #4.

As illustrated in FIG. 10, in Table 2, the set of cells may be a set of any of CC #5 to CC #7. Index 0 may be associated with CC #5, index 1 may be associated with CC #5 and CC #6, index 2 may be associated with CC #5, CC #6, and CC #7, and index 3 may be associated with CC #6.

Here, when Table 1 and Table 2 are configured, the number of cells that can be scheduled using the specific DCI is seven from CC #1 to CC #6. Although not particularly limited, the upper limit of the number of cells (that is, the number of cells in a set of cells (table) ) that can be scheduled using the single specific DCI may be four.

Second, cells that are actually scheduled may be specified by a field included in the specific DCI. The field included in the specific DCI is a field including an index described above. Thus, for each cell (index) that is actually scheduled, the specific DCI is configured which is different in payload size, CCE index, SS (Search Space) setting, or the like.

For example, if index 3 in Table 1 is specified by the specific DCI, cells scheduled using the specific DCI are CC #1, CC #2, CC #3, and CC #4. In contrast, if index 3 in Table 2 is specified using the specific DCI, a cell scheduled using the specific DCI is CC #6.

Third, for a field having Type 3 (Type 3 field), a sub-group is applied to a cell that is actually scheduled (Co-scheduled cells). A sub-group includes one or more cells. The Type 3 field may be called a specific field.

For example, when index 3 in Table 1 is specified by the specific DCI, CC #1, CC #2, CC #3, and CC #4 are classified into one or more sub-groups. For example, CC #1 and CC #2 may be classified into sub-group #1, and CC #3 and CC #4 may be classified into sub-group #2. In contrast, when index 3 in Table 2 is specified by the specific DCI, CC #6 is classified into a sub-group. For example, CC #6 may be classified into one of sub-group #1 and sub-group #2.

### (4.1) Operation Example 1

Operation example 1 describes constraints on a set of cells that can be scheduled using the specific DCI. The following options can be considered as the constraints on the set of groups.

In option 1-1, the upper limit of the number of sets of groups which can be configured may be specified in advance in the radio communication system 10. The upper limit of the number of sets of groups which can be configured may be reported as a UE capability regarding the UE 200.

For example, it may be specified in advance in the radio communication system 10 that the upper limit of the number of sets of groups which can be configured is “1”. A UE capability may be specified which reports that the upper limit of the number of sets of groups which can be configured is “1”. A UE capability may be specified which reports that the upper limit of the number of sets of groups which can be configured is “2 or more”.

In option 1-2, the upper limit of the number of tables which can be configured may be specified in advance in the radio communication system 10. The upper limit of the number of tables which can be configured may be reported as UE a capability regarding the UE 200.

For example, it may be specified in advance in the radio communication system 10 that the upper limit of the number of tables which can be configured is “1”. A UE capability may be specified which reports that the upper limit of the number of tables which can be configured is “1”. A UE capability may be specified which reports that the upper limit of the number of tables which can be configured is “2 or more”.

Option 1-2 may be considered as a replacement of option 1-1.

In option 1-3, the upper limit of the total number of cells which can be configured in all of one or more sets of groups (tables) may be specified in advance in the radio communication system 10. The upper limit of the total number of cells which can be configured in all of one or more sets of groups (tables) may be reported as a UE capability regarding the UE 200.

In option 1-4, when two or more sets of groups (tables) are configured, the UE 200 may receive a MAC CE or DCI which instructs activation or deactivation of a set of groups (table) which is actually used.

In option 1-5, a set of cells (table) of cells which can be scheduled using the specific DCI may be notified by at least one of a cell that executes scheduling using the specific DCI (scheduling cell) or a cell that is scheduled using the specific DCI (scheduled cell).

According to operation example 1, by specifying constraints on a set of groups (tables) of cells which can be scheduled using the specific DCI, Multi carrier scheduling using the specific DCI including a Type 3 field can be appropriately operated. For example, it is possible to prevent a situation where merits of Multi carrier scheduling are lost due to too many sets of groups (tables).

### (4.2) Operation Example 2

Operation example 2 explains how to define a sub-group (that is, the specification method described above). Here, an example is given of a case where the above-described Table 1 is configured.

First, a possible configuration of a sub-group will be described. The following options can be considered as the possible configuration of the sub-group. The configuration of the sub-group is an example of a specification method of assuming the sub-group by the UE 200 or the gNB 100.

In option 2-1-1, the sub-group may be different for each Type 3 field. For example, the sub-group may be different for each Type 3 field included in the specific DCI. For example, for a DCI field XX having Type 3 (for example, TCI, Antenna port, MCS, etc.) port, MCS, etc.), CC #1 and CC #2 may be classified into the same sub-group, and for a DCI field YY having Type 3 (for example, FDRA, etc.) , CC #1 and CC #3 may be classified into the same sub-group.

Option 2-1-1 is an example of a specification method of assuming different sub-groups for one or more Type 3 fields having Type 3.

In option 2-1-2, the sub-group may be the same for all Type 3 fields. For example, the sub-group may be defined for each set of cells (table). For example, when Table 1 is configured, CC #1 and CC #2 may always be classified into the same sub-group.

Option 2-1-2 is an example of a specification method of assuming the same sub-group for one or more Type 3 fields having Type 3.

In option 2-1-3, the UE 200 and the gNB 100 may assume that at least one Type 3 field setting is the same among cells included in the same sub-group. The UE 200 and the gNB 100 may not assume that the Type 3 field setting differs among cells included in the same sub-group. For example, the UE 200 and the gNB 100 may assume that a BWP setting (for example, BandwidthPart-Config) of cells included in the same sub-group is the same. The UE 200 and the gNB 100 may assume that an Antenna port setting (for example, PUSCH-tp, DL-DMRS-config-type, DL-DMRS-config-max-len, or Rank) of cells included in the same sub-group is the same.

Second, defining a Type 3 field to which sub-groups including the same cell are applied will be described. The following options are possible regarding how to define a Type 3 field to which sub-groups including the same cell are applied. The method of defining a Type 3 field is an example of a specification method of assuming a sub-group by the UE 200 or the gNB 100.

In option 2-2-1, a (type of) Type 3 field to which sub-groups including the same cell are applied may be specified in advance in the radio communication system 10, or may be configured using a higher layer parameter. In option 2-2-1, a sub-group may be considered common to all of the Type 3 fields included in the specific DCI.

Option 2-2-1 is an example of a specification method of assuming the same sub-group for one or more Type 3 fields having Type 3.

In option 2-2-2, two or more Type 3 field groups, to which sub-groups including the same cell are applied, may be specified in advance in the radio communication system 10, or may be configured using a higher layer parameter. Taking two or more Type 3 field groups as objects, option 2-2-2 may be considered as classifying Type 3 fields, to which different sub-groups are applied, into sub-groups. Taking the above option 2-1-1 as an example, as a Type 3 field to which a sub-group including CC #1 and CC #2 is applied, DCI field XX (for example, TCI, Antenna port, MCS, etc.) may be specified in advance in the radio communication system 10, or may be configured by a higher layer parameter. As a Type 3 field to which a sub-group including CC #1 and CC #3 is applied, DCI field YY (for example, FDRA) may be specified in advance in the radio communication system 10, or may be configured using a higher layer parameter.

Option 2-2-2 is an example of a specification method of assuming different sub-groups for one or more Type 3 fields having Type 3.

Third, a method of defining a sub-group will be described. As a method of defining a sub-group, the following methods can be considered. A method of defining a sub-group is an example of a specification method of assuming a sub-group by the UE 200 or gNB 100.

In option 2-3-1, a sub-group may be configured using a higher layer parameter. That is, option 2-3-1 is an example of a specification method of assuming that a sub-group is configured using a higher layer parameter.

For example, the higher layer parameter may be a parameter that configures a sub-group for each Type 3 field. As described in option 2-2-2, the higher layer parameter may be a parameter that configures a sub-group for each group of Type 3 fields. As described in Option 2-1-2, the higher layer parameter may be a parameter that configures a sub-group for each set of cells (table).

In option 2-3-2, a sub-group may be defined to include a cell that satisfies a specific condition. The specific condition is a condition defined for a configuration which a cell has. That is, option 2-3-2 is an example of a specification method of assuming that cells which satisfy a specific condition are classified into a sub-group.

For example, a specific condition may be that cells belong to the same band. For example, when CC #1 and CC #2 are Intra-band, CC #1 and CC #2 may be classified into the same sub-group. When CC #1 and CC #4 are Inter-band, CC #1 and CC #4 may be classified into separate sub-groups.

In option 2-3-3, a sub-group may be defined to include a cell that satisfies a specific condition. A specific condition is a condition where the content configured using a higher layer parameter for a cell is defined. That is, option 2-3-3 is an example of a specification method of assuming that cells which satisfy a specific condition are classified into a sub-group.

For example, a sub-group may be defined to include cells having the same BWP configuration (for example, at least one of locationAndBandwidth, subcarrierSpacing, or cyclicPrefix).

For example, a sub-group may be defined to include cells each having the same N_RBG (Resource Block Group). N_RBG indicates the total number of RBGs.

For example, a sub-group may be defined to include cells each having the same configuration regarding a field included in the DCI. The configuration of each cell may be regarding one or more fields selected from MCS, Antenna port, TCI, HPN, FDRA, VRB-to-PRB mapping, PRB bundling size indicator, Rate matching indicator, ZP CSI-RS trigger, SRS request, DMRS initialization, Frequency hopping flag, TPC command for scheduled PUSCH, Precoding information and number of layers, SRS resource indicator, PTRS-DMRS association, CSI request, and Open-loop power control parameter set indication.

In option 2-3-4, a method of defining a sub-group (option 2-3-1 to 2-3-3) may be different for each Type 3 field.

For example, for Type 3 fields, such as MCS, Antenna port, and TCI, a sub-group defined using option 2-3-2 (for example, a specific condition where a cell belongs to an Intra-band) may be applied. For FDRA, a sub-group defined using option 2-3-3 (for example, a specific condition where cells have the same N_RBG) may be applied.

According to operation example 2, a sub-group can be appropriately assumed for the specific DCI including a Type 3 field by specifying a specification method where a sub-group is defined.

### (4.3) Operation Example 3

Operation example 3 describes the number of sub-groups and the number of cells included in a sub-group.

In option 3-1, the UE 200 may report a UE Capability indicating whether or not to support a sub-group to be applied to a type 3 field. The UE 200 may report a UE Capability indicating whether or not the UE 200 supports at least one of the options in operation example 1 described above. The UE 200 may report a UE Capability indicating whether or not the UE 200 supports at least one of the options in operation example 2 described above.

In option 3-2, the upper limit of the number of sub-groups may be specified in advance in the radio communication system 10 and may be reported as a UE capability regarding the UE 200. For example, it may be specified in advance in the radio communication system 10 that the upper limit of the number of sub-groups included in a set of cells (table) is “2”. A UE capability may be specified that reports which of “1”, “2”, “3”, or “4” is supported as the upper limit of the number of sub-groups included in a set of cells (table).

In option 3-3, the upper limit of the number of cells included in a sub-group may be specified in advance in the radio communication system 10 and may be reported as a UE capability regarding the UE 200. For example, the upper limit of the number of cells included in a sub-group may be any one of “1”, “2”, “3”, and “4”. When it is possible to define the upper limit for each sub-group, the upper limit of the number of cells included in a sub-group may be two or more values Selected from “1”, “2”, “3”, and “4”.

According to operation example 3, the number of sub-groups, and the number of cells included in a sub-group can be appropriately defined by specifying a UE capability regarding the number of sub-groups, and the number of cells included in a sub-group.

According to operation example 3, Multi carrier scheduling using specific DCI including a Type 3 field can be appropriately operated by defining the upper limit of the number of sub-groups and the number of cells included in a sub-group.

### (5) Actions and Effects

In the embodiment, the UE 200 assumes a sub-group to be applied to a specific type (Type 3) which a field (Type 3 field) included in the specific DCI has, using a specification method. With this configuration, a sub-group can be appropriately assumed for the specific DCI including a Type 3 field by specifying a specification method for defining a sub-group.

### (6) Other Embodiments

Although the contents of the present invention have been described in accordance with the above embodiment, the present invention is not limited to these descriptions, and it is obvious to those skilled in the art that various modifications and improvements thereof are possible.

In the above disclosure, a UE Capability may be reported to a scheduling cell and may be reported to a scheduled cell. When a UE Capability is reported to a scheduled cell, the UE Capability may be notified from the scheduled cell to a scheduling cell.

In the above disclosure, configure, activate, update, Indicate, enable, specify, and select may be read interchangeably. Similarly, link, associate, correspond, and map may be read interchangeably, and allocate, assign, monitor, and map may also be read interchangeably.

Furthermore, specific, dedicated, UE-specific, and UE-individual may be read interchangeably. Similarly, common, shared, group-common, UE-common, and UE-shared may be read interchangeably.

Note that the block diagrams (FIG. 4 and FIG. 5) that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate pieces of apparatus (for example, via wire, wireless, or the like) and using these plurality of pieces of apparatus. The functional blocks may be implemented by combining software into the apparatus described above or the plurality of apparatuses described above.

Functions include judgment, determination, decision, calculation, computation, processing, derivation, investigation, search, confirmation, reception, transmission, output, access, resolution, Selection, designation, establishment, comparison, assumption, expectation, considering, broadcasting, notifying, communicating, forwarding, configuring, reconfiguring, allocating (mapping), assigning, and the like, but function are by no means limited to these. For example, functional block (components) to implement a function of transmission may be referred to as a “transmitting section (transmitting unit)”, a “transmitter”, and the like. The method for implementing each component is not particularly limited as described above.

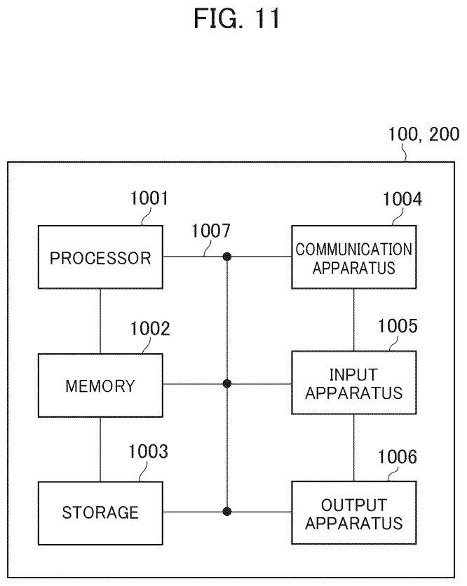

The eNB 100 and the UE 200 (apparatuses) which are described above may function as a computer that executes the processes of the radio communication method of the present disclosure. FIG. 11 is a diagram to illustrating an example of a hardware structure of the apparatuses. As illustrated in FIG. 11, the apparatuses may each be formed as a computer apparatus that includes a processor 1001, a memory 1002, a storage 1003, a communication apparatus 1004, an input apparatus 1005, an output apparatus 1006, a bus 1007, and so on.

Note that in the present disclosure, the words such as an apparatus, a circuit, a device, a unit, and so on can be interchangeably interpreted. The hardware structure of the apparatuses may be configured to include one or more of apparatuses shown in the drawings, or may be configured not to include part of apparatuses.

Each functional block of the apparatuses (see FIG. 4) is implemented by any of hardware elements of the computer apparatus or a combination of the hardware elements.

Each function of the apparatuses is implemented, for example, by allowing certain software (programs) to be read on hardware such as the processor 1001 and the memory 1002, and by allowing the processor 1001 to perform calculations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least part of the operations of the above-described embodiments are used. The various processes have been described to be performed by a single processor 1001. However, the processes may be performed by two or more processors 1001 simultaneously or sequentially. The processor 1001 may be implemented by one or more chips. It should be noted that the program may be transmitted from a network via a telecommunication line.

The memory 1002 is a computer-readable recording medium, and may be constituted with, for example, at least one of a Read Only Memory (ROM), an Erasable Programmable ROM (EPROM), an Electrically Erasable Programmable ROM (EEPROM), a Random Access Memory (RAM), and other appropriate storage media. The memory 1002 may be referred to as a “register”, a “cache”, a “main memory (primary storage apparatus)” and so on. The memory 1002 can store executable programs (program codes), software modules, and the like for implementing the method according to one embodiment of the present disclosure.

The storage 1003 is a computer-readable recording medium, and may be constituted with, for example, at least one of an optical disk such as a Compact Disc ROM (CD-ROM), a hard disk drive, a flexible disk, a magneto-optical disk (for example, a compact disk, a digital versatile disk, Blu-ray (Registered Trademark) disk), a smart card, a flash memory (for example, a card, a stick, a key drive), a floppy (Registered Trademark) disk, a magnetic strip, and other appropriate storage media. The storage 1003 may be referred to as “auxiliary storage apparatus”. The above recording medium may be a database including the memory 1002 and/or the storage 1003, a server, or any other appropriate medium.

The communication apparatus 1004 is hardware (transmitting/receiving device) for allowing inter-computer communication via at least one of wired and wireless networks, and may be referred to as, for example, a “network device”, a “network controller”, a “network card”, a “communication module”, and so on.

The communication apparatus 1004 may be configured to include a high frequency switch, a duplexer, a filter, a frequency synthesizer, and so on in order to realize, for example, at least one of frequency division duplex (FDD) and time division duplex (TDD).

The input apparatus 1005 is an input device that receives input from the outside (for example, a keyboard, a mouse, a microphone, a switch, a button, a sensor, and so on). The output apparatus 1006 is an output device that allows sending output to the outside (for example, a display, a speaker, a Light Emitting Diode (LED) lamp, and so on). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between pieces of apparatus.

Also, the apparatuses may be structured to include hardware such as a microprocessor, a digital signal processor (DSP), an Application Specific Integrated Circuit (ASIC), a Programmable Logic Device (PLD), a Field Programmable Gate Array (FPGA), and so on, and part or all of the functional blocks may be implemented by the hardware. For example, the processor 1001 may be implemented with at least one of these pieces of hardware.

Notification of information is by no means limited to the aspects/embodiments described in the present disclosure, and other methods may be used as well. For example, notification of information in the present disclosure may be implemented by using physical layer signaling (for example, Downlink Control Information (DCI), Uplink Control Information (UCI) ), higher layer signaling (for example, RRC signaling, Medium Access Control (MAC) signaling, broadcast information (Master Information Block (MIB), System Information Block (SIB), and so on)), and other signals or combinations of these. Also, RRC signaling may be referred to as an “RRC message”, and can be, for example, an RRC Connection Setup message, an RRC Connection Reconfiguration message, and so on.

The aspects/embodiments illustrated in the present disclosure may be applied to Long Term Evolution (LTE), LTE-Advanced (LTE-A), SUPER 3G, IMT-Advanced, 4th generation mobile communication system (4G), 5th generation mobile communication system (5G), 6th generation mobile communication system (6G), xth generation mobile communication system (xG) (for example, x is an integer or decimal), Future Radio Access (FRA), New Radio (NR), W-CDMA (registered trademark), GSM (registered trademark), CDMA 2000, Ultra Mobile Broadband (UMB), IEEE 802.11 (Wi-Fi (registered trademark) ), IEEE 802.16 (WiMAX (registered trademark) ), IEEE 802.20, Ultra-WideBand (UWB), Bluetooth (registered trademark), systems that use other adequate systems, next-generation systems that are enhanced based on these, or combinations of these. A plurality of systems may be combined (for example, a combination of at least one of LTE and LTE-A, and 5G, and the like) for application.

The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

Operations which have been described in the present disclosure to be performed by a base station may, in some cases, be performed by an upper node of the base station. In a network including one or a plurality of network nodes with the base station, it is clear that various operations that are performed to communicate with the terminal can be performed by the base station, one or more network nodes (for example, MME, S-GW, and so on may be possible, but these are not limiting) other than the base station, or combinations of these. According to the above, a case is described in which there is a single network node other than the base station. However, a combination of multiple other network nodes may be considered (e.g., MME and S-GW).

The information or signals described in this disclosure may be output from a higher layer (or lower layer) to a lower layer (or higher layer). The information or signals may be input or output through multiple network nodes.

The input or output information may be stored in a specific location (e.g., memory) or managed using management tables. The input or output information may be overwritten, updated, or added. The information that has been output may be deleted. The information that has been input may be transmitted to another apparatus.

A decision or a determination in an embodiment of the present invention may be realized by a value (0 or 1) represented by one bit, by a boolean value (true or false), or by comparison of numerical values (e.g., comparison with a predetermined value).

Each aspect/embodiment described in the present specification may be used independently, may be used in combination, or may be used by switching according to operations. Further, notification (transmission/reporting) of predetermined information (e.g., notification (transmission/reporting) of “X”) is not limited to an explicit notification (transmission/reporting), and may be performed by an implicit notification (transmission/reporting) (e.g., by not performing notification (transmission/reporting) of the predetermined information).

Software should be broadly interpreted to mean, whether referred to as software, firmware, middle-ware, microcode, hardware description language, or any other name, instructions, instruction sets, codes, code segments, program codes, programs, subprograms, software modules, applications, software applications, software packages, routines, subroutines, objects, executable files, executable threads, procedures, functions, and the like.

Further, software, instructions, information, and the like may be transmitted and received via a transmission medium. For example, in the case where software is transmitted from a website, server, or other remote source using at least one of wired line technologies (such as coaxial cable, fiber optic cable, twisted pair, digital subscriber line (DSL), etc. ) or wireless technologies (infrared, microwave, etc.) , at least one of these wired line technologies or wireless technologies is included within the definition of the transmission medium.

Information, a signal, or the like, described in the present specification may be represented by using any one of various different technologies. For example, data, an instruction, a command, information, a signal, a bit, a symbol, a chip, or the like, described throughout the present application, may be represented by a voltage, an electric current, electromagnetic waves, magnetic fields, a magnetic particle, optical fields, a photon, or a combination thereof.

It should be noted that a term used in the present specification and a term required for understanding of the present specification may be replaced by a term having the Same or similar meaning. For example, at least one of a channel or a symbol may be a signal (signaling). Further, a signal may be a message. Further, the Component Carrier (CC) may be referred to as a carrier frequency, cell, frequency carrier, or the like.

As used in the present disclosure, the terms “system” and “network” are used interchangeably.

Further, the information, parameters, and the like, described in the present disclosure may be expressed using absolute values, relative values from predetermined values, or they may be expressed using corresponding different information. For example, a radio resource may be what is indicated by an index.

The names used for the parameters described above are not used as limitations. Further, the mathematical equations using these parameters may differ from those explicitly disclosed in the present disclosure. Because the various channels (e.g., PUCCH, PDCCH) and information elements may be identified by any suitable names, the various names assigned to these various channels and information elements are not used as limitations.

In the present disclosure, the terms such as a “Base Station (BS)”, a “radio base station”, a “fixed station”, a “NodeB”, an “eNB (eNodeB)”, a “gNB (gNodeB)”, an “access point”, a “transmission point”, a “reception point” , a “transmission/reception point”, a “cell”, a “sector”, a “cell group”, a “carrier”, a “component carrier”, and so on can be used interchangeably. The base station may be referred to as the terms such as a “macro cell”, a “small cell”, a “femto cell”, a “pico cell”, and so on.

The base station can accommodate one or a plurality of (for example, three) cells (also called sectors). When the base station accommodates a plurality of cells, the entire coverage area of the base station can be partitioned into multiple smaller areas, and each smaller area can provide communication services through base station subsystems (for example, indoor small base stations (Remote Radio Heads (RRHs))).

The term “cell” or “sector” refers to part of or the entire coverage area of at least one of the base station and a base station subsystem that provides communication services within this coverage.

In the present disclosure, “the base station transmits information to the terminal” may be read as “the base station instructs the terminal to perform a control or an operation based on information”.

In the present disclosure, the terms “Mobile Station (MS)”, “user terminal”, “User Equipment (UE)”, and “terminal” may be used interchangeably.

A mobile station may be referred to as a “subscriber station”, a “mobile unit”, a “subscriber unit”, a “wireless unit”, a “remote unit”, a “mobile device”, a “wireless device”, a “wireless communication device”, a “remote device”, a “mobile subscriber station”, an “access terminal”, a “mobile terminal”, a “wireless terminal”, a “remote terminal”, a “handset”, a “user agent”, a “mobile client”, a “client”, or some other appropriate terms in some cases.

At least one of the base station and the mobile station may be referred to as a “transmitting apparatus”, a “receiving apparatus”, a “radio communication apparatus”, and so on. Note that at least one of the base station and the mobile station may be a device mounted on a moving object, a moving object itself, and so on. The moving object may be a vehicle (for example, a car, an airplane, and the like), may be a moving object which moves unmanned (for example, a drone, an automatic operation car, and the like), or may be a robot (a manned type or unmanned type). Note that at least one of the base station and the mobile station also includes an apparatus which does not necessarily move during communication operation. For example, at least one of the base station and the mobile station may be an Internet of Things (IOT) device such as a sensor.

Furthermore, the base station in the present disclosure may be interpreted as a user station (user terminal, the same applies hereinafter). For example, each aspect/embodiment of the present disclosure may be applied to the structure that replaces a communication between the base station and the user station with a communication between a plurality of user stations (for example, which may be referred to as “Device-to-Device (D2D)”, “Vehicle-to-Everything (V2X)”, and the like). In this case, the user stations may have the functions of the base station described above. The words such as “uplink” and “downlink” may be interpreted as the words corresponding to the terminal-to-terminal communication (for example, “sidelink”). For example, an uplink channel, a downlink channel and so on may be interpreted as a sidelink channel.

Likewise, the user station in the present disclosure may be interpreted as the base station. In this case, the base station may have the functions of the user station.

A radio frame may be constituted of one or a plurality of frames in the time domain. Each of one or a plurality of frames in the time domain may be referred to as a “subframe”.

Furthermore, a subframe may be constituted of one or a plurality of slots in the time domain. A subframe may be a fixed time length (for example, 1 ms) independent of numerology.

Numerology may be a communication parameter applied to at least one of transmission and reception of a certain signal or channel. For example, numerology may indicate at least one of a SubCarrier Spacing (SCS), a bandwidth, a symbol length, a cyclic prefix length, a Transmission Time Interval (TTI), the number of symbols per TTI, a radio frame structure, a specific filter processing performed by a transceiver in the frequency domain, a specific windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot”. A mini-slot may be constituted of symbols less than the number of slots. A PDSCH (or PUSCH) transmitted in a time unit larger than a mini-slot may be referred to as “PDSCH (PUSCH) mapping type A”. A PDSCH (or PUSCH) transmitted using a mini-slot may be referred to as “PDSCH (PUSCH) mapping type B”.

A radio frame, a subframe, a slot, a mini-slot, and a symbol all express time units in signal communication. A radio frame, a subframe, a slot, a mini-slot, and a symbol may each be called by other applicable terms.

For example, one subframe may be referred to as a “TTI”, a plurality of consecutive subframes may be referred to as a “TTI”, or one slot or one mini-slot may be referred to as a “TTI”. In other words, at least one of a subframe and a TTI may be a subframe (1 ms) in existing LTE, may be a period shorter than 1 ms (for example, 1 to 13 symbols), or may be a period longer than 1 ms. Note that a unit expressing TTI may be referred to as a “slot”, a “mini-slot”, or the like, instead of a “subframe”.

Here, a TTI refers to the minimum time unit of scheduling in radio communication, for example. For example, in LTE systems, the base station performs, for user terminals, scheduling of allocating radio resources (such as a frequency bandwidth and transmit power available for each user terminal) in TTI units. Note that the definition of the TTI is not limited to this.

The TTI may be a transmission time unit for channel-encoded data packets (transport blocks), code blocks, codewords, or the like, or may be a unit of processing in scheduling, link adaptation, or the like. Note that, when a TTI is given, a time interval (for example, the number of symbols) to which transport blocks, code blocks, codewords, or the like are actually mapped may be shorter than the TTI.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI”, a “normal subframe”, a “long subframe”, a “slot”, or the like. A TTI that is shorter than a normal TTI may be referred to as a “shortened TTI”, a “short TTI”, a “partial or fractional TTI”, a “shortened subframe”, a “short subframe”, a “mini-slot”, a “sub-slot”, a “slot” and so on.

Note that a long TTI (for example, a normal TTI, a subframe, or the like) may be interpreted as a TTI having a time length exceeding 1 ms, and a short TTI (for example, a shortened TTI or the like) may be interpreted as a TTI having a TTI length shorter than the TTI length of a long TTI and equal to o longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

An RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB) )”, a “Sub-Carrier Group (SCG)”, a “Resource Element Group (REG)”, a “PRB pair”, an “RB pair” and so on.

Furthermore, a resource block may be constituted of one or a plurality of Resource Elements (REs). For example, one RE may correspond to a radio resource field of one subcarrier and one symbol.

A Bandwidth Part (BWP) (which may be referred to as a “fractional bandwidth”, and so on) may represent a subset of contiguous common resource blocks (common RBs) for certain numerology in a certain carrier. Here, a common RB may be specified by an index of the RB based on the common reference point of the carrier. A PRB may be defined by a certain BWP and may be numbered in the BWP.

The BWP may include a UL BWP (BWP for UL) and a DL BWP (BWP for DL). One or a plurality of BWPs may be configured in one carrier for a UE.

At least one of configured BWPs may be active, and a UE may not need to assume to transmit/receive a certain signal/channel outside the active BWP(s). Note that a “cell”, a “carrier”, and so on in the present disclosure may be interpreted as a “BWP”.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

The term “connected” or “coupled” or any variation thereof means any direct or indirect connection or coupling between two or more elements and may include the presence of one or more intermediate elements between the two elements “connected” or “coupled” with each other. The coupling connection between the elements may be physical, logical, or a combination thereof. For example, “connection” may be read as “access”. As used in the present disclosure, the two elements may be thought of as being “connected” or “coupled” to each other using at least one of the one or more wires, cables, or printed electrical connections and, as a number of non-limiting and non-inclusive examples, electromagnetic energy having wavelengths in the radio frequency region, the microwave region, and the light (both visible and invisible) region.

A reference signal may be abbreviated as an “RS”, and may be referred to as a “pilot”, depending on which standard applies.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

“Means” included in the configuration of each of the above apparatuses may be replaced by “parts”, “circuits”, “devices”, etc.

Reference to elements with designations such as “first”, “second”, and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

In the case where the terms “include”, “including” and variations thereof are used in the present disclosure, these terms are intended to be comprehensive in the same way as the term “comprising”. Further, the term “or” used in the present specification is not intended to be an “exclusive or”.

In the present disclosure, where an article is added by translation, for example “a”, “an”, and “the”, the disclosure may include that the noun following these articles is plural.

As used herein, the term “determining” may encompasses a wide variety of actions. For example, “determining” may be regarded as judging, calculating, computing, processing, deriving, investigating, looking up, search inquiry (e.g., looking up in a table, a database or another data structure), ascertaining and the like. Also, “determining” may be regarded as receiving (e.g., receiving information), transmitting (e.g., transmitting information), inputting, outputting, accessing (e. g., accessing data in a memory) and the like. Also, “determining” may be regarded as resolving, selecting, choosing, establishing, comparing and the like. That is, “determining” may be regarded as a certain type of action related to determining. Furthermore, “determining” may be regarded as “assuming”, “expecting”, “considering”, and the like.

In this disclosure, the term “A and B are different” may mean “A and B are different from each other”. It should be noted that the term “A and B are different” may mean “A and B are different from C”. Terms such as “separated” or “combined” may be interpreted in the same way as the above-described “different”.

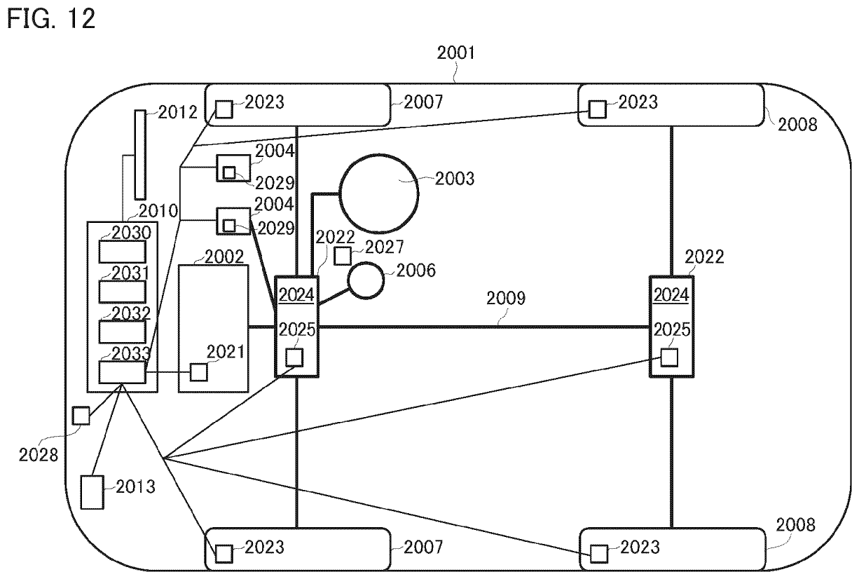

FIG. 12 illustrates an example of a configuration of a vehicle 2001. As illustrated in FIG. 12, the vehicle 2001 includes a drive unit 2002, a steering unit 2003, an accelerator pedal 2004, a brake pedal 2005, a shift lever 2006, a front wheel 2007, a rear wheel 2008, an axle 2009, an electronic control unit 2010, various sensors 2021 to 2029, an information service unit 2012, and a communication module 2013.

The drive unit 2002 may include, for example, an engine, a motor, and a hybrid of an engine and a motor.

The steering unit 2003 includes at least a steering wheel and is configured to steer at least one of the front wheel and the rear wheel, based on the operation of the steering wheel operated by the user.

The electronic control unit 2010 includes a microprocessor 2031, a memory (ROM, RAM) 2032, and a communication port (IO port) 2033. The electronic control unit 2010 receives signals from the various sensors 2021 to 2027 provided in the vehicle 2001. The electronic control unit 2010 may be referred to as an ECU (Electronic control unit).

The signals from the various sensors 2021 to 2028 include a current signal from a current sensor 2021 which senses the current of the motor, a front or rear wheel rotation signal acquired by a revolution sensor 2022, a front or rear wheel pneumatic signal acquired by a pneumatic sensor 2023, a vehicle speed signal acquired by a vehicle speed sensor 2024, an acceleration signal acquired by an acceleration sensor 2025, a stepped-on accelerator pedal signal acquired by an accelerator pedal sensor 2029, a stepped-on brake pedal signal acquired by a brake pedal sensor 2026, an operation signal of a shift lever acquired by a shift lever sensor 2027, and a detection signal, acquired by an object detection sensor 2028, for detecting an obstacle, a vehicle, a pedestrian, and the like.

The information service unit 2012 includes various devices for providing various kinds of information such as driving information, traffic information, and entertainment information, including a car navigation system, an audio system, a speaker, a television, and a radio, and one or more ECUS controlling these devices. The information service unit 2012 provides various types of multimedia information and multimedia services to the occupants of the vehicle 1 by using information obtained from the external device through the communication module 2013 or the like.

A driving support system unit 2030 includes: various devices for providing functions of preventing accidents and reducing driver's operating loads such as a millimeter wave radar, a LiDAR (Light Detection and Ranging), a camera, a positioning locator (e.g., GNSS, etc.), map information (e.g., high definition (HD) map, autonomous vehicle (AV) map, etc.), a gyro system (e.g., IMU (Inertial Measurement Unit), INS (Inertial Navigation System), etc.), an AI (Artificial Intelligence) chip, and an AI processor; and one or more ECUs controlling these devices. In addition, the driving support system unit 2030 transmits and receives various types of information via the communication module 2013 to realize a driving support function or an autonomous driving function.

The communication module 2013 may communicate with the microprocessor 2031 and components of the vehicle 1 via a communication port. For example, the communication module 2013 transmits and receives data via a communication port 2033, to and from the drive unit 2002, the steering unit 2003, the accelerator pedal 2004, the brake pedal 2005, the shift lever 2006, the front wheel 2007, the rear wheel 2008, the axle 2009, the microprocessor 2031 and the memory (ROM, RAM) 2032 in the electronic control unit 2010, and sensors 2021 to 2028 provided in the vehicle 1.

The communication module 2013 is a communication device that can be controlled by the microprocessor 2031 of the electronic control unit 2010 and that is capable of communicating with external devices. For example, various kinds of information are transmitted to and received from external devices through radio communication. The communication module 2013 may be internal to or external to the electronic control unit 2010. The external devices may include, for example, a base station, a mobile station, or the like.

The communication module 2013 transmits the current signal from the current sensor, which is input to the electronic control unit 2010, to external devices through radio communication. In addition, the communication module 2013 transmits to external devices through radio communication, the front or rear wheel rotation signal acquired by the revolution sensor 2022, the front or rear wheel pneumatic signal acquired by the pneumatic sensor 2023, the vehicle speed signal acquired by the vehicle speed sensor 2024, the acceleration signal acquired by the acceleration sensor 2025, the stepped-on accelerator pedal signal acquired by the accelerator pedal sensor 2029, the stepped-on brake pedal signal acquired by the brake pedal Sensor 2026, the operation signal of the shift lever acquired by the shift lever sensor 2027, and the detection signal, acquired by the object detection sensor 2028, for detecting an obstacle, a vehicle, a pedestrian, and the like.

The communication module 2013 receives various types of information (traffic information, signal information, inter-vehicle information, etc.) transmitted from the external devices and displays the received information on the information service unit 2012 provided in the vehicle. In addition, the communication module 2013 stores the various types of information received from the external devices in the memory 2032 available to the microprocessor 2031. Based on the information stored in the memory 2032, the microprocessor 2031 may control the drive unit 2002, the steering unit 2003, the accelerator pedal 2004, the brake pedal 2005, the shift lever 2006, the front wheel 2007, the rear wheel 2008, the axle 2009, the sensors 2021 to 2028, etc., mounted in the vehicle 2001.

As described above, the present invention has been described in detail. It is apparent to a person skilled in the art that the present invention is not limited to one or more embodiments of the present invention described in the present specification. Modifications, alternatives, replacements, etc., of the present invention may be possible without departing from the subject matter and the scope of the present invention defined by the descriptions of claims. Therefore, the descriptions of the present specification are for illustrative purposes only, and are not intended to be limitations to the present invention.

### Supplementary Note

The disclosure described above may be expressed as follows.

According to a first feature, there is provided a terminal including: a receiving unit that receives single specific downlink control information for scheduling channels to be transmitted on two or more carriers; and a control unit that assumes, using a specification method, a sub-group to be applied to a specific type which a field included in the specific downlink information has, wherein the specific type is a type that has one field which specifies information common to one or more carriers included in the sub-group.

According to a second feature, there is provided the terminal in the first feature, in which the specification method includes at least one of: a method of assuming a same sub-group for one or more fields having the specific type; or a method of assuming different sub-groups for one or more fields having the specific type.

According to a third feature, there is provided the terminal in the first feature or the second feature, in which the specification method includes at least one of: a method of assuming that the sub-group is configured using a higher layer parameter; or a method of assuming that a cell satisfying a specific condition is classified into the sub-group.

According to a fourth feature, there is provided a base station including: a transmitting unit that transmits single specific downlink control information for scheduling channels to be transmitted on two or more carriers; and a control unit that assumes, using a specification method, a sub-group to be used in a specific type which a specific field included in the specific downlink information has, wherein the specific type is a type that has one field which specifies information common to one or more carriers included in the sub-group.

According to a fifth feature, there is provided a radio communication system including: a terminal; and a base station, wherein the terminal includes: a receiving unit that receives single specific downlink control information for scheduling channels to be transmitted on two or more carriers; and a control unit that assumes, using a specification method, a sub-group to be applied to a specific type which a field included in the specific downlink information has, wherein the specific type is a type that has one field which specifies information common to one or more carriers included in the sub-group.

According to a sixth feature, a radio communication method including: a step A of receiving single specific downlink control information for scheduling channels to be transmitted on two or more carriers; and a step B of assuming, using a specification method, a sub-group to be applied to a specific type which a field included in the specific downlink information has, wherein the specific type is a type that has one field which specifies information common to one or more carriers included in the sub-group.

### EXPLANATION OF REFERENCE NUMERALS

10 radio communication system
20 NG-RAN
100 gNB
110 receiving unit
120 transmitting unit
130 control unit
200 UE
210 radio signal transmitting and receiving unit
220 amplifier unit
230 modulation and demodulation unit
240 control signal and reference signal processing unit
250 encoding and decoding unit
260 data transmitting and receiving unit
270 control unit
1001 processor
1002 memory
1003 storage
1004 communication apparatus
1005 input apparatus
1006 output apparatus
1007 bus
2001 vehicle
2002 drive unit
2003 steering unit
2004 accelerator pedal
2005 brake pedal
2006 shift lever
2007 front wheel
2008 rear wheel
2009 axle
2010 electronic control unit
2012 information service unit
2013 communication module
2021 current sensor
2022 revolution sensor
2023 pneumatic sensor
2024 vehicle speed sensor
2025 acceleration sensor
2026 brake pedal sensor
2027 shift lever sensor
2028 object detection sensor
2029 accelerator pedal sensor
2030 driving support system unit
2031 microprocessor
2032 memory (ROM, RAM)
2033 communication port

1. A terminal comprising:
a receiving unit that receives single specific downlink control information for scheduling channels to be transmitted on two or more carriers; and
a control unit that assumes, using a specification method, a sub-group to be applied to a specific type which a field included in the specific downlink information has, wherein
the specific type is a type that has one field which specifies information common to one or more carriers included in the sub-group.

2. The terminal according to claim 1, wherein the specification method includes at least one of: a method of assuming a same sub-group for one or more fields having the specific type; or a method of assuming different sub-groups for one or more fields having the specific type.

3. The terminal according to claim 1, wherein the specification method includes at least one of: a method of assuming that the sub-group is configured using a higher layer parameter; or a method of assuming that a cell satisfying a specific condition is classified into the sub-group.

4. A base station comprising:
a transmitting unit that transmits single specific downlink control information for scheduling channels to be transmitted on two or more carriers; and
a control unit that assumes, using a specification method, a sub-group to be used in a specific type which a specific field included in the specific downlink information has, wherein
the specific type is a type that has one field which specifies information common to one or more carriers included in the sub-group.

5. A radio communication system comprising:
a terminal; and a base station, wherein
the terminal includes:
a receiving unit that receives single specific downlink control information for scheduling channels to be transmitted on two or more carriers; and
a control unit that assumes, using a specification method, a sub-group to be applied to a specific type which a field included in the specific downlink information has, wherein
the specific type is a type that has one field which specifies information common to one or more carriers included in the sub-group.

6. A radio communication method comprising:
a step A of receiving single specific downlink control information for scheduling channels to be transmitted on two or more carriers; and
a step B of assuming, using a specification method, a sub-group to be applied to a specific type which a field included in the specific downlink information has, wherein
the specific type is a type that has one field which specifies information common to one or more carriers included in the sub-group.
